(19) United States
(12) Patent Application Publication
(10) Pub. No.: US 2014/0020350 A1
(43) Pub. Date: Jan. 23, 2014

(54) AIR FILTER MEDIA

(71) Applicant: K.J.Filtration Technologies LTD., Luzhu Township (TW)

(72) Inventor: STEVEN FU, Luzhu Township (TW)

(21) Appl. No.: 13/943,344

(22) Filed: Jul. 16, 2013

(30) Foreign Application Priority Data
Jul. 18, 2012 (TW) 101213839

(51) Int. Cl. B01D 46/54

(52) U.S. Cl. CPC B01D 46/546
USPC 55/486

(57) ABSTRACT

The present disclosure relates generally to an air filter media. In one embodiment, the air filter media includes a nonwoven fabric substrate, and a nanofiber layer formed on a surface of the nonwoven fabric substrate. A fiber diameter of the nonwoven fabric substrate is from 100 nm to 400 nm.

### RELATED APPLICATIONS

This application claims priority to Taiwan Application Serial Number 101213839, filed Jul. 18, 2012, which is herein incorporated by reference in its entirety.

### BACKGROUND

1. Field of Invention

The present invention relates to a filter media. More particularly, the present invention relates to an air filter media for High Efficiency Particle Air (HEPA) filter application

2. Description of Related Art

High Efficiency Particle Air (HEPA) filters are widely used in commercial and industrial air handling units for meeting air cleanliness requirement, and in household air cleaners for improving living and health qualities. However, currently available HEPA filters are not ecologically friendly enough, therefore there is room for improvement.

Most commonly seen HEPA filters are produced with micro glass fiber media. Glass fiber is an inorganic material which is harmful to human health. Glass fiber does not decompose naturally therefore is not ecologically friendly. Furthermore, HEPA filters made with glass fiber media usually creates higher pressure drop in the air handler therefore consumes more energy to operate.

Another commonly seen HEPA filter media is produced with melt-blown polypropylene nonwoven. For melt-blown nonwoven to sustain high efficiency and low pressure drop, it will have to be electrostatically charged. However, this method is not ideally suited for most critical applications because the electrostatic charge can be lost due to humidity and temperature fluctuation hence can cause filtration efficiency to reduce to a lower level than prescribed.

In addition, both methods described above require large amount of material to reach HEPA level of efficiency therefore the material cost is higher.

### SUMMARY

The present invention provides an air filter media made by electrostatic spinning technology, which is able to achieve HEPA level efficiency with very low material usage, and with significant pressure drop reduction.

An aspect of the invention provides an air filter media. The air filter media includes a nonwoven fabric substrate, and an electrostatic spun nanofiber layer formed on a surface of the nonwoven fabric substrate. A fiber diameter of the nonwoven fabric substrate is form 100 nm to 400 nm. The nanofiber layer can be formed on one side of the nonwoven fabric substrate, or one layer each on both sides of the substrate. The fiber diameter of the nanofiber layer can be uniform throughout, or the fiber diameter can increase gradually starting from the side contacting substrate on up to form a gradient structure for to improve dust loading. No adhesive is used between the nonwoven fabric substrate and the nanofiber layer. The nanofiber layer is in direct contact with the nonwoven fabric substrate.

The nanofiber layer is formed on the nonwoven fabric substrate by electrostatic spinning technology. Only a small amount (in weight) of the nanofiber is required to achieve high filtration efficiency, therefore marginal difference in media weight or pressure drop when increasing efficiency level is minimal. Furthermore, the nanofiber layer is formed on the nonwoven fabric substrate directly without adhesive, so that the pores of the air filter media would not be blocked by adhesive.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of an embodiment of an air filter media of the invention;

FIG. 2 is a schematic diagram of another embodiment of the air filter media of the invention; and

FIG. 3 is a schematic diagram of an embodiment of an apparatus for fabricating the air filter media of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

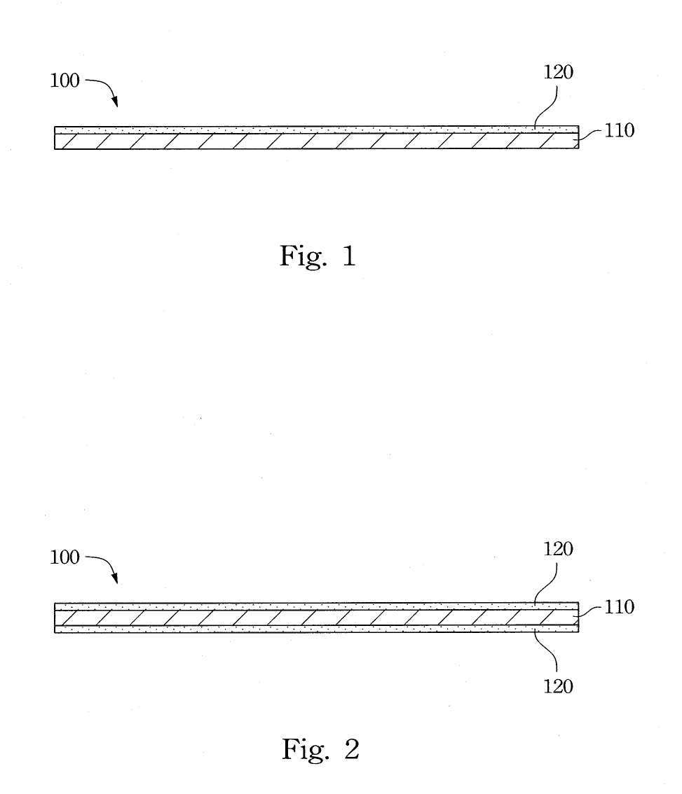

FIG. 1 is a schematic diagram of an embodiment of an air filter media of the invention. The air filter media 100 includes a nonwoven fabric substrate 110 and a nanofiber layer 120. The nanofiber layer is formed on a surface of the nonwoven fabric substrate 110. The present invention uses the electrostatic spinning technique to form the nanofiber layer 120 on the nonwoven fabric substrate 110 directly. The nanofiber layer 120 can be an electrostatic spun nanofiber layer. Namely, there is no adhesive between the nanofiber layer 120 and the nonwoven fabric substrate 110 to adhere the nanofiber layer 120 on the nonwoven fabric substrate 110. The nanofiber is spun and in contact with the nonwoven fabric substrate 110 and is further bonded on the nonwoven fabric substrate 110. The nanofiber made by the electrostatic spinning technique has a characteristic of thin diameter, therefore pores of the air filter media 100 using the nanofiber can be highly decreased, and a filtration efficiency of the air filter media 100 can also be improved. In one experiment, the filtration of the air filter media 100 can be higher than 99.97%, which can be utilized in HEPA and P3 standard mask, for example.

The nonwoven fabric substrate 110 can be made of polyethylene terephthalate (PET) or rayon cellulose. A fiber diameter of the nanofiber layer is about from 100 nm to 400 nm. The nanofiber layer 120 can be made of water-soluble polymer, such as a polyvinyl alcohol (PVA). The cost of such polymer solution is less than the glass fiber. Furthermore, PVA is an organic polymer, which can be recycled. Namely, the nanofiber layer 120 can be recycle, which is good for environment.

In this embodiment, the nanofiber layer is formed on a single surface of the nonwoven fabric substrate 110. The fiber diameter of the nanofiber layer 120 can be adjusted according to a formula of the polymer solution or a voltage of an applied electric field. The fiber diameter of the nanofiber layer 120 can be increased from a side near the nonwoven fabric substrate 110 to a side away from the nonwoven fabric substrate 110. Namely, the fiber diameter can increase gradually starting from the side contacting the nonwoven fabric substrate 110 on up to form a gradient structure for to improve dust loading. The fiber of the nanofiber layer 120 near the nonwoven fabric substrate 110 has a thinner diameter, and the fiber of the nanofiber layer 120 away from the nonwoven fabric substrate 110 has a thicker diameter. When the air filter media 100 is utilized, the nonwoven fabric substrate 110 is used as a supporter and is opposite to an external environment, i.e. the air enters the air filter media 100 from the side of nanofiber layer 120. The diameter of the fiber of the nanofiber away from the nonwoven fabric substrate 110 is thicker than the diameter of the fiber near the nonwoven fabric substrate 110. Therefore, the pores of the nanofiber layer 120 away from the nonwoven fabric substrate 110 are larger than the pores near the nonwoven fabric substrate 110. The larger particles in the air can be previously filtered by the larger pores thereby preventing the pores of nanofiber layer 120 are blocked by the large particles at once.

Of course, in other embodiments, the fiber diameter of the nanofiber layer 120 can be uniform.

FIG. 2 is a schematic diagram of another embodiment of the air filter media of the invention. In this embodiment, two of the nanofiber layers 120 are formed in opposite surfaces of the nonwoven fabric substrate 110 respectively. Namely, the nanofiber layers 120 are formed in a manner of one layer each on both sides of the nonwoven fabric substrate. The nanofiber layers 120 and the nonwoven fabric substrate 110 can be made of material disclosed above. The fiber diameter of the nanofiber layer 120 can be uniform. The fiber diameter of the nanofiber layer 120 can be increased from a side near the nonwoven fabric substrate 110 to a side away from the nonwoven fabric substrate 110. The fiber diameter of the nanofiber layer 120 can be uniform throughout, or the fiber diameter can increase gradually starting from the side contacting the nonwoven fabric substrate 110 on up to form a gradient structure for to improve dust loading.

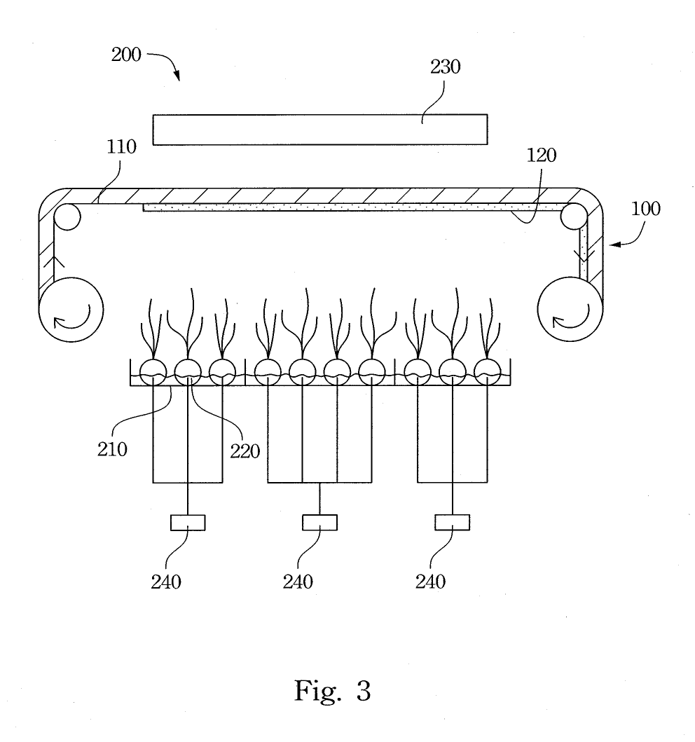

FIG. 3 is a schematic diagram of an embodiment of an apparatus for fabricating the air filter media of the invention. An electrostatic spinning apparatus 200 includes a plurality of tanks 210, a plurality of emitting electrodes 220, a collecting electrode 230, and a high-voltage power supply 240. The tanks 210 are used to provide a polymer solution. The polymer solution is provided to the emitting electrodes 220. The high-voltage power supply 240 is at least connected to the emitting electrodes 220, so that the polymer solution can be repelled by the high-voltage like charge and become electrostatic spinning fibers. The electrostatic spinning fibers are led to the collecting electrode 230. The nonwoven fabric substrate 110 passes through between the emitting electrodes 220 and the collecting electrode 230, so that the electrostatic spinning fibers are applied on a surface of the nonwoven fabric substrate 110 to form the nanofiber layer 120 thereon. Noted that the electrostatic spinning apparatus 200 in FIG. 3 is not illustrated according to real ratio in order to clearly perform the feature of the invention.

The fiber diameter of the fibers in the nanofiber layer 120 can be controlled by adjusting the formula of the polymer solution in different tanks 210 or adjusting the voltage applied by the high-voltage power supply 240. In some embodiments, the diameter of the electrostatic spinning fibers spun by the emitting electrodes 220 can be uniform. In other embodiments, the emitting electrode near an inlet of the nonwoven fabric substrate 110 may spin thinner electrostatic spinning fibers, and the emitting electrode 220 near an outlet of the nonwoven fabric substrate 110 may spin thicker electrostatic spinning fibers.

The diameter of the electrostatic spinning fibers is very thin thereby satisfying nanofiber standard. The basic weight or the pressure loss need not be increased while raising the filtration efficiency of the air filter media 100. The electrostatic spinning fibers are applied on the nonwoven fabric substrate 110. Therefore an adhesive is not necessary, and the pores of the air filter media 100 would not be blocked by the adhesive.

According to the embodiments disclosed above, the invention has following advantages. The nanofiber layer is formed on the nonwoven fabric substrate by electrostatic spinning technology. Only a small amount (in weight) of the nanofiber is required to achieve high filtration efficiency, therefore marginal difference in media weight or pressure drop when increasing efficiency level is minimal. Furthermore, the nanofiber layer is formed on the nonwoven fabric substrate directly without an adhesive, so that the pores of the air filter media would not be blocked because of the adhesive.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An air filter media comprising:
a nonwoven fabric substrate; and
a nanofiber layer formed on a surface of the nonwoven fabric substrate, wherein a fiber diameter of the nonwoven fabric substrate is from 100 nm to 400 nm.

2. The air filter media of claim 1, wherein the nanofiber layer is formed on a single surface of the nonwoven fabric substrate.

3. The air filter media of claim 1, wherein two of the nanofiber layers are formed on two opposite surfaces of the nonwoven fabric substrate respectively.

4. The air filter media of claim 1, wherein the fiber diameter of the nanofiber layer is uniform.

5. The air filter media of claim 1, wherein the fiber diameter of the nanofiber layer is increased from a side near the nonwoven fabric substrate to a side away from the nonwoven fabric substrate.

6. The air filter media of claim 1, wherein there is no adhesive between the nonwoven fabric substrate and the nanofiber layer.

7. The air filter media of claim 1, wherein the nanofiber layer is in direct contact with the nonwoven fabric substrate.

8. The air filter media of claim 1, wherein the nanofiber layer is an electrostatic spun nanofiber layer.
